(19) United States
(12) Patent Application Publication
(10) Pub. No.: US 2010/0059037 A1
(43) Pub. Date: Mar. 11, 2010

(54) STACKABLE CHARCOAL STARTER

(75) Inventors: Theodore Andrew Witzel, Kitchener (CA); Christian Wayne Robinson, Kitchener (CA); Benjamin Michael Harrison, Waterloo (CA)

Correspondence Address: DARYL W SCHNURR;MILLER THOMSON LLP, ACCELERATOR BUILDING, 295 HAGEY BLVD., SUITE 300, WATERLOO, ON, N2L 6R5, CA

(73) Assignee: Onward Multi-Corp. Inc.

(21) Appl. No.: 12/207,297

(22) Filed: Sep. 9, 2008

(51) Int. Cl. A47J 37/07; B65D 85/00

(52) U.S. Cl. 126/25 B; 220/2

(57) ABSTRACT

A stackable charcoal starter for use in lighting charcoal comprises a base having a continuous wall extending upward therefrom, the wall having a plurality of air inlet openings near its lower end and an opening at its upper end. In a preferred embodiment, the wall extends frusto-conically from a larger upper end to a smaller lower end. A handle assembly located near an upper end of the wall has a first section extending outward from the wall and a second section extending downward from the first section. A shield for protecting a user's hands from the hot surface of the wall extends downward from the first section between the wall and the second section. The first section comprises an aperture of a size sufficient to receive a handle assembly and heat shield of an identical charcoal starter with the result that identical charcoal starters can be stacked on top of one another in close relation.

### BACKGROUND OF THE INVENTION

1. Field of the Invention

The present invention relates to charcoal starters for igniting charcoal for use in outdoor grills, and, in particular, to stackable charcoal starters having a heat shield and which is adapted for two-handed operation.

2. Description of the Prior Art

Charcoal starters for rapidly igniting charcoal for use in outdoor grills are well known in the art. Specifically, previous charcoal starters, also known as chimney starters, are described in U.S. Pat. Nos. 3,453,975; 3,957,455; 3,167,040; 4,227,510; 4,282,854; 4,461,270; 4,531,507; 4,604,986; 5,469,835; 6,009,867; and 6,913,013, among others. Some of the previous devices have a vented metal container for holding the charcoal or a heat shield extending along one side and a handle disposed outwardly from the heat shield for protecting a user's hand from heat conducted through the walls of the container. It is known to have a charcoal starter with tapered side walls, but without a handle. Since the charcoal in the starter must be removed from the starter when the charcoal has been ignited, a handle is most desirable.

Secure handling of the charcoal starter is especially important when the starter is filled with ignited charcoal. Many of the charcoal starters known in the art employ a single handle system for pouring the heated charcoal out of the starter and onto a grill or other suitable cooking surface. Dual handle systems for promoting secure two-handed operation of the starter are also known. These dual handle systems permit a user to grip the charcoal starter with both hands with the result that the starter may be safely and securely manipulated by the user.

Owing to their bulk and size, charcoal starters of the prior art variety are not amenable to efficient shipping or transport. In addition, storing multiple charcoal starters can be difficult. Accordingly, a need exists for a charcoal starter having the desired safety features of a heat shield and a dual handle assembly, and which is stackable, or nestable, with other like charcoal starters for economical and space-conserving transporting, displaying and storing.

### SUMMARY OF THE INVENTION

The present invention is directed to a stackable charcoal starter for use in lighting charcoal comprising an open base having a continuous wall extending upward therefrom. The wall has a plurality of air inlet openings near its lower end and an opening at its upper end. In a preferred embodiment, the wall extends frusto-conically from a larger upper end to a smaller lower end. A handle assembly located near an upper end of the wall has a first section extending outward from the wall and a second section extending downward from the first section. A heat shield for protecting a user's hands from the hot surface of the wall extends downward from the first section between the wall and the second section. The heat shield is spaced away from the wall such that air is allowed to pass between the heat shield and the wall. The first section comprises an aperture of a size sufficient to receive a handle assembly and heat shield of an identical charcoal starter with the result that identical charcoal starters can be stacked, or nested, on top of each another in close relation for the purpose of transporting, displaying or storing multiple starters. In operation, a user of the stackable charcoal starter of the present invention is able to grip the first section of the handle assembly with one hand while simultaneously gripping the second section of the handle assembly with his or her other hand. The handle assembly is referred to as a two-handle system because of the handle and heat shield. This two-handle system allows for secure carrying of the charcoal starter and safe pouring of the heated charcoal disposed therein.

It is an object of the present invention to provide a novel charcoal starter for use in lighting charcoal having the desired safety features of a heat shield and a dual handle assembly, and which is stackable with other like charcoal starters. It is a further object of the present invention to provide a charcoal starter that is of simple and economical construction.

Yet another object of the present invention is to provide a charcoal starter which is capable of being transported, displayed and stored in an efficient and space-conserving manner with other like charcoal starters.

These and other objects will become obvious to persons having ordinary skill in the art to which the present invention relates upon examination of the detailed description and the accompanying drawings which follow.

A stackable charcoal starter is used to light charcoal. The starter comprises a container having an open top and bottom with at least one wall converging from the top to the bottom. The container has a charcoal support located near the bottom, the at least one wall having a plurality of air inlet openings near the bottom. A handle assembly having a first upper section extends outward from the at least one wall, and a second section extending downward from an outer end of the first section. The second section extends slightly off vertical and has a handle thereon. A heat shield extends downward from the first section between the at least one wall and the second section, the heat shield being off vertical. The first section has an aperture therein immediately outside the heat shield. The starter is stackable with other identical starters, the aperture having a cross-sectional area that is sufficiently large to receive a heat shield from one or more other stackable starters.

### BRIEF DESCRIPTION OF THE DRAWINGS

FIG. 1 is a perspective view of the stackable charcoal starter of the present invention;

FIG. 2 is a side view of the stackable charcoal starter of FIG. 1;

FIG. 3 is an alternate perspective view of the stackable charcoal starter of the present invention;

FIG. 4 is a top view of the stackable charcoal starter of FIG. 1;

FIG. 5 is a side view of multiple stackable charcoal starters of the present invention in a stacked configuration; and

FIG. 6 is a perspective view of the stackable charcoal starters of FIG. 5.

### DETAILED DESCRIPTION OF A PREFERRED EMBODIMENT

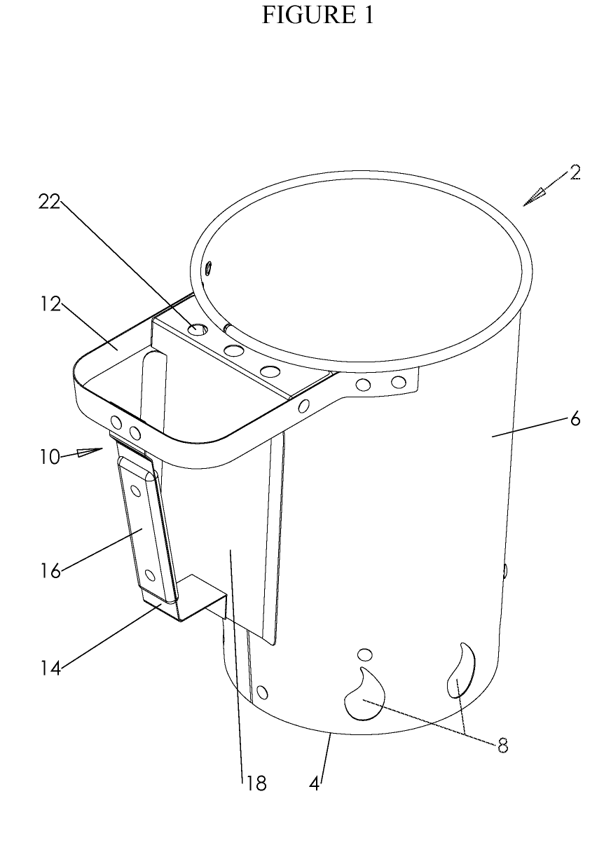

Referring to the drawings and initially to FIG. 1, a stackable charcoal starter is shown generally at reference numeral 2. The charcoal starter 2 comprises an open base 4 having at least one wall 6 surrounding the base 4 and extending upward therefrom. In a preferred embodiment, the at least one wall 6 is continuous and extends frusto-conically from a larger upper end to a smaller lower end. The at least one wall 6 contains a plurality of air inlet openings 8 at its lower end and an opening at its upper end. A handle assembly, indicated generally by reference numeral 10, comprises a first upper section 12 extending outward from the at least one wall 6 and a second outer section 14 extending downward from the first section 12. A heat shield 18 for protecting a user's hands from the hot surface of the at least one wall 6 extends downward from the first section 12 between the at least one wall 6 and the second section 14. A handle 16 is disposed on the second section 14 for gripping the charcoal starter 2. In a preferred embodiment, a plurality of vents 22 are located in the first section 12 of the handle assembly 10 in a position between the heat shield 18 and the at least one wall 6. The inclusion of the vents 22 facilitates the passage of air between the heat shield 18 and the at least one wall 6 in order to aid in safeguarding the heat shield 18 from the hot temperature of the at least one wall 6.

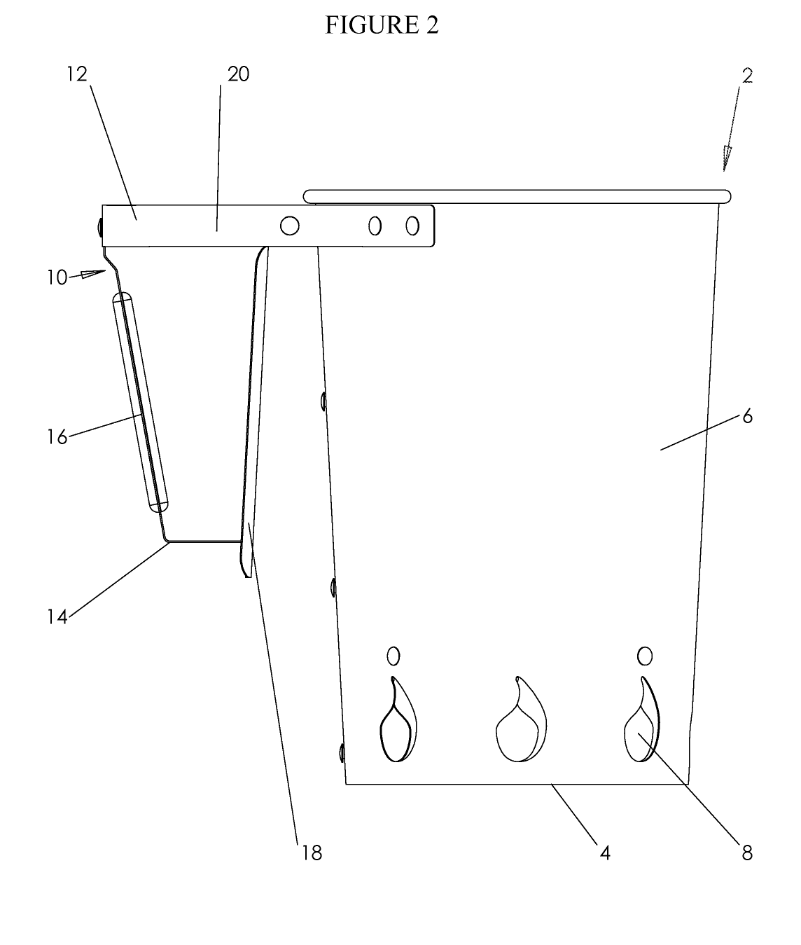

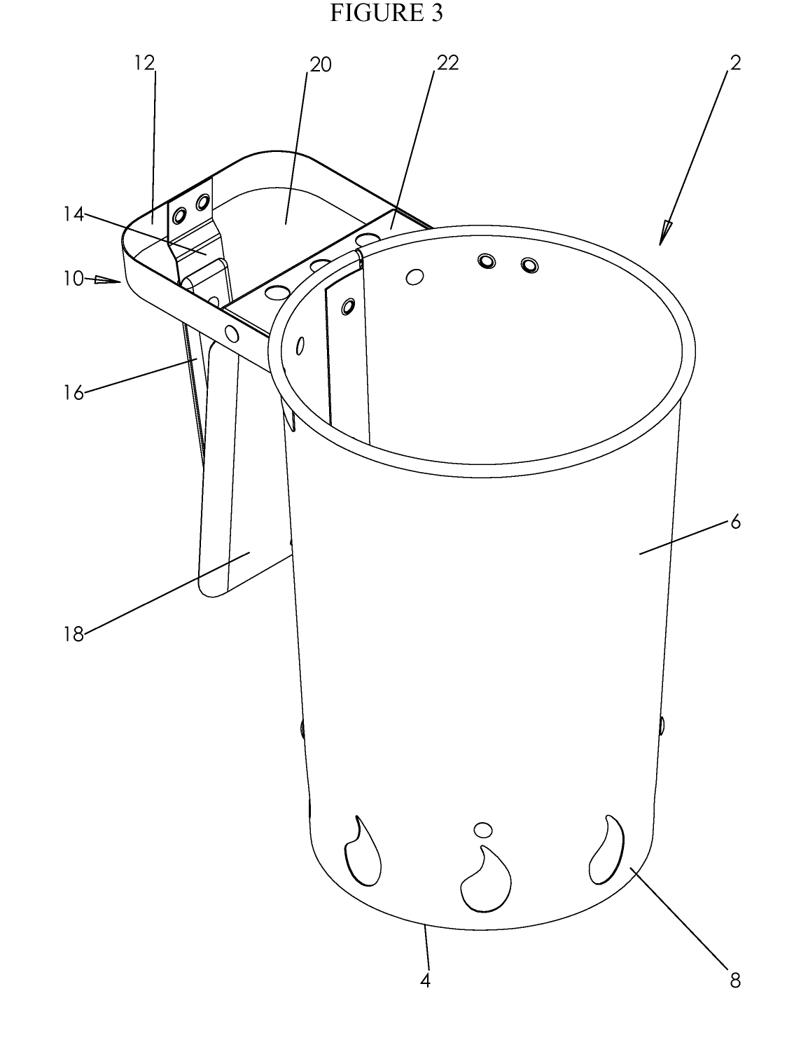

As shown in FIGS. 2 and 3, in a preferred embodiment, the first section 12 substantially conforms to a C-shape, and connects to the at least one wall 6 at its open ends to define an aperture 20. The aperture 20 is located immediately outward from the heat shield 18 and is bounded at its outer end by the first section 12 and part of the second section 14. The aperture 20 has a cross-sectional area that is sufficiently large to receive a heat shield from another identical charcoal starter. As can be seen in FIG. 2, the second section 14 extends slightly off vertical and is angled slightly inward in the direction of the at least one wall 6. The heat shield 18 similarly extends slightly off vertical, but is angled slightly outward toward the handle 16, such that the respective angles of the second section 14 and the heat shield 18 follow a convergent path. This orientation enables multiple heat shields and handle assemblies to stack, or nest, within like heat shields and handle assemblies.

In order to increase the stability of the handle assembly 10, the bottom portion of the second section 14 may be designed to contain a horizontal extension at its lower end, which extension is anchored or otherwise affixed to the lower portion of the heat shield 18.

The handle 16 is preferably composed of an insulated material. For example, the handle may be insulated by two pieces of wood, or two pieces of resin, which pieces are affixed to the inner and outer surfaces of the handle 16. If desired, insulated pieces could also be wrapped around portions of the inner and outer surfaces of the first section 12. The entire charcoal starter 2, including the handle assembly 10, but excluding the insulated portions of the handle 16 is preferably composed of a flame resistant material such as metal or galvanized steel.

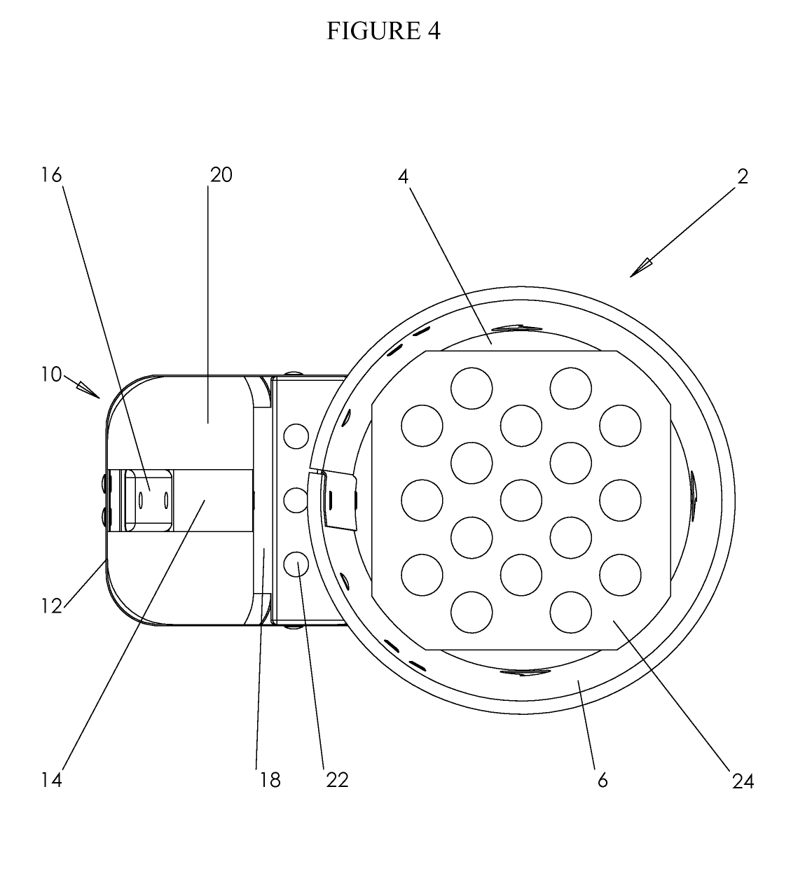

As shown in FIG. 4, a support tray 24 for supporting charcoal briquettes extends substantially horizontally within the at least one wall 6 of the starter 2. In a preferred embodiment, the support tray 24 is positioned directly above the air inlet openings 8. The support tray 24 itself is porous in order to facilitate the movement of hot air from the lower end of the starter 2 to the location of the charcoal briquettes. The support tray 24 is secured to the inside portion of the at least one wall 6 using any suitable means, such as screws, rivets, or the like.

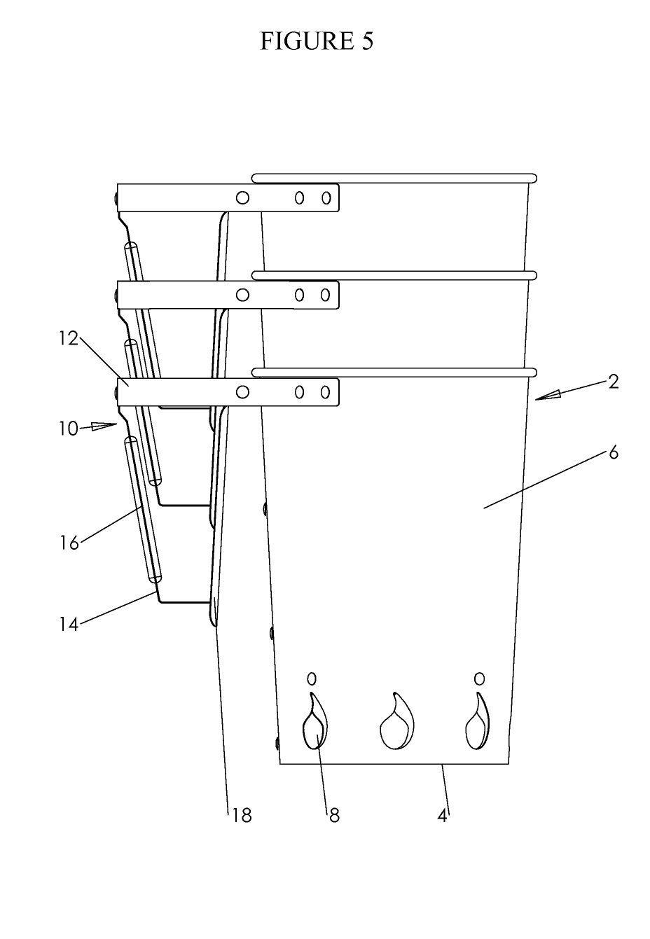

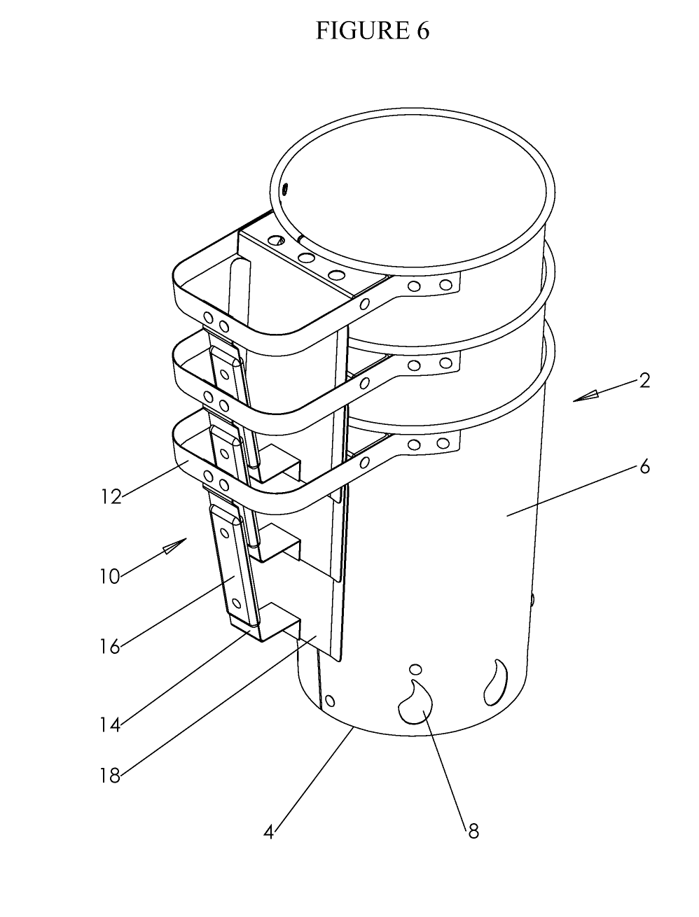

In FIGS. 5 and 6, multiple charcoal starters are shown stacked, or nested, on top of one another. As shown in their stacked configuration, it can be seen that the at least one wall 6 of each charcoal starter 2 is shaped to receive the identical at least one wall 6 of a like starter 2. It can further be seen that the heat shield 18 and handle assembly 10 of each starter 2 are similarly shaped and oriented to receive the identical heat shield 18 and handle assembly 10 of a like starter 2.

In operation, a user of the charcoal starter 2 places charcoal briquettes within the at least one wall 6 of the starter 2. The charcoal briquettes are supported within the at least one wall 6 by the support tray 24, which tray is horizontally disposed near the lower end of the starter 2. The user then lights the charcoal briquettes by placing a lit match or similar substitute within an air inlet opening 8 beneath the support tray 24. When it is determined that the charcoal briquettes have become sufficiently ignited, the user lifts the charcoal starter 2 by gripping the handle 16 with one hand while simultaneously placing the other hand around a portion of the first section 12. By engaging in two-handed operation of the starter 2, as opposed to one-handed operation, the starter is safer and easier to manipulate. At this stage, the heat shield 18 protects the user's hand from the extreme heat generated by the lighted charcoal briquettes, which heat is conducted to the outer portions of the at least one wall 6. The user may then proceed to pour the ignited charcoal briquettes onto an outdoor grill or other suitable cooking surface.

In summary, a charcoal starter for use in lighting charcoal which is stackable with other like starters comprises an open base having at least one wall extending upward and lower therefrom, the at least one wall diverging to an open top and converging to an open bottom, the at least one wall having a plurality of air inlet openings therein, in a location just above the base. A porous charcoal support is disposed within the at least one wall in a location directly above the air inlet openings. A handle assembly located on the at least one wall has a first upper section extending outward from the at least one wall, and a second outer section extending downward from an outer end of the first section. The second section extends slightly off vertical by angling slightly inward toward the at least one wall and has a handle thereon. A heat shield extends downward from the first section between the at least one wall and the second section. The heat shield is off vertical by angling slightly outward toward the handle. The first section has an aperture therein. The aperture is located immediately outward of the heat shield and bounded by the second section, and has a cross-sectional area that is sufficiently large to receive a heat shield from one or more other stackable charcoal starters.

While one or more embodiments of this invention have been illustrated in the accompanying drawings and described above, it will be evident to those skilled in the art that changes and modifications can be made therein without departing from the essence of this invention. All such modifications are believed to be within the sphere and scope of the invention as defined by the claims appended hereto. For example, the heat shield could be angled inward rather than outward or the handle can be angled outward rather than inward, though the orientation shown in the drawings is preferred.

We claim:

1. A stackable charcoal starter for use in lighting charcoal, said starter comprising a container having an open top and bottom with at least one wall converging from said top to said bottom, said container having a charcoal support located near said bottom, said at least one wall having a plurality of air inlet openings therein near said bottom, a handle assembly having a first upper section extending outward from said at least one wall, and a second outer section extending downward from an outer end of said first section, said second section extending slightly off vertical and having a handle thereon, a heat shield extending downward from said first section between said at least one wall and said second section, said heat shield being off vertical, said first section having an aperture therein immediately outside of said heat shield, said starter being stackable with other identical starters, said aperture having a cross-sectional area that is sufficiently large to receive a heat shield from one or more other stackable starters.

2. A stackable charcoal starter as claimed in claim 1, wherein said second section is off vertical by being angled slightly inward.

3. A stackable charcoal starter as claimed in claim 2, wherein said heat shield is off vertical by being angled slightly outward.

4. A stackable charcoal starter as claimed in claim 3, wherein a bottom end of said second section is anchored to a bottom of said heat shield.

5. A stackable charcoal starter as claimed in claim 4, wherein said second section extends substantially horizontally to be anchored on said heat shield.

6. A stackable charcoal starter as claimed in any one of claims 1, 2, or 3, wherein said handle is made from insulated material.

7. A stackable charcoal starter as claimed in any one of claims 1, 2, or 3, wherein said charcoal starter, except for an insulated portion of said handle, is made from metal.

8. A stackable charcoal starter as claimed in any one of claims 1, 2, or 3, wherein said charcoal starter, except for an insulated portion of said handle, is made from galvanized steel.

9. A stackable charcoal starter as claimed in any one of claims 1, 2, or 3, wherein said handle is insulated by two pieces of wood affixed to inner and outer surfaces of a metal portion of said handle.

10. A stackable charcoal starter as claimed in any one of claims 1, 2, or 3, wherein said handle is insulated by two pieces of resin affixed to inner and outer surfaces of a metal portion of said handle.

11. A stackable charcoal starter as claimed in any one of claims 1, 2, or 3, wherein there are one or more vents in said first section located between said heat shield and said at least one wall.

12. A stackable charcoal starter wherein said starter is shaped to be stacked vertically with other identical stackable starters, with said at least one wall of one starter fitting substantially inside an at least one wall of another starter and said handle assemblies also fitting substantially inside one another.
